(19) United States
(12) Patent Application Publication
(10) Pub. No.: US 2026/0051301 A1
(43) Pub. Date: Feb. 19, 2026

(54) LIQUID CRYSTAL DISPLAY DEVICE

(71) Applicant: Sharp Display Technology Corporation, Kameyama City (JP)

(72) Inventors: Shunsuke NOICHI, Kameyama City (JP); Noriyuki TANAKA, Kameyama City (JP); Tatsuhiko SUYAMA, Kameyama City (JP)

(21) Appl. No.: 19/254,177

(22) Filed: Jun. 30, 2025

(30) Foreign Application Priority Data
Aug. 16, 2024 (JP) 2024-136912

(51) Int. Cl. G09G 3/36

(52) U.S. Cl. CPC G09G 3/3688; G09G 2300/0426; G09G 2300/0842; G09G 2320/0247; G09G 2330/021; G09G 2340/0435

(57) ABSTRACT

A liquid crystal display device includes a pixel including a pixel electrode, a first power source line, and a second power source line, wherein the pixel includes a first memory circuit, a second memory circuit, a first transistor connected to the first memory circuit, and a second transistor connected to the second memory circuit, and the pixel electrode is connected to the first power source line via the first transistor and is connected to the second power source line via the second transistor.

### CROSS-REFERENCE TO RELATED APPLICATIONS

This application claims the benefit of priority to Japanese Patent Application Number 2024-136912 filed on Aug. 16, 2024. The entire contents of the above-identified application are hereby incorporated by reference.

### BACKGROUND

### Technical Field

The disclosure relates to a liquid crystal display device.

JP 2012-93436 A discloses a liquid crystal display device including a DRAM memory in a pixel.

### SUMMARY

There is a problem that a refresh frequency is high and power consumption is large in a known memory display type liquid crystal display device.

A liquid crystal display device according to one aspect of the disclosure includes a pixel including a pixel electrode, a first power source line, and a second power source line, in which the pixel includes a first memory circuit, a second memory circuit, a first transistor connected to the first memory circuit, and a second transistor connected to the second memory circuit, and the pixel electrode is connected to the first power source line via the first transistor and is connected to the second power source line via the second transistor.

In a liquid crystal display device that can perform memory display, the refresh frequency can be reduced while maintaining a quality of the memory display.

### BRIEF DESCRIPTION OF DRAWINGS

The disclosure will be described with reference to the accompanying drawings, wherein like numbers reference like elements.

FIG. 1 is a block diagram illustrating a configuration of portions of a liquid crystal display device according to the embodiment.

FIG. 2 is a circuit diagram illustrating a pixel configuration example of a liquid crystal display device.

FIG. 3 is a schematic view illustrating an operation example of a liquid crystal display device according to the embodiment.

FIG. 4 is a schematic view illustrating an operation example of a liquid crystal display device according to the embodiment.

FIG. 5 is a schematic view illustrating an operation example of a liquid crystal display device according to the embodiment.

FIG. 6 is a schematic view illustrating an operation example of a liquid crystal display device according to the embodiment.

FIG. 7 is a schematic view illustrating an operation example of a liquid crystal display device according to the embodiment.

FIG. 8 is a schematic view illustrating an operation example of a liquid crystal display device according to the embodiment.

FIG. 9 is a schematic view illustrating an operation example of a liquid crystal display device according to the embodiment.

FIG. 10 is a schematic view illustrating an operation example of a liquid crystal display device according to the embodiment.

FIG. 11 is a schematic view illustrating an operation example of a liquid crystal display device according to the embodiment.

FIG. 12 is a schematic view illustrating an operation example of a liquid crystal display device according to the embodiment.

FIG. 13 is a schematic view illustrating an operation example of a liquid crystal display device according to the embodiment.

FIG. 14 is a schematic view illustrating an operation example of a liquid crystal display device according to the embodiment.

FIG. 15 is a timing chart showing an example of signal waveforms of a first and a second data lines and a first and a second control lines.

FIG. 16 is a timing chart showing an example of signal waveforms of the first and the second control lines.

FIG. 17 is a circuit diagram illustrating a known pixel configuration example.

### DESCRIPTION OF EMBODIMENTS

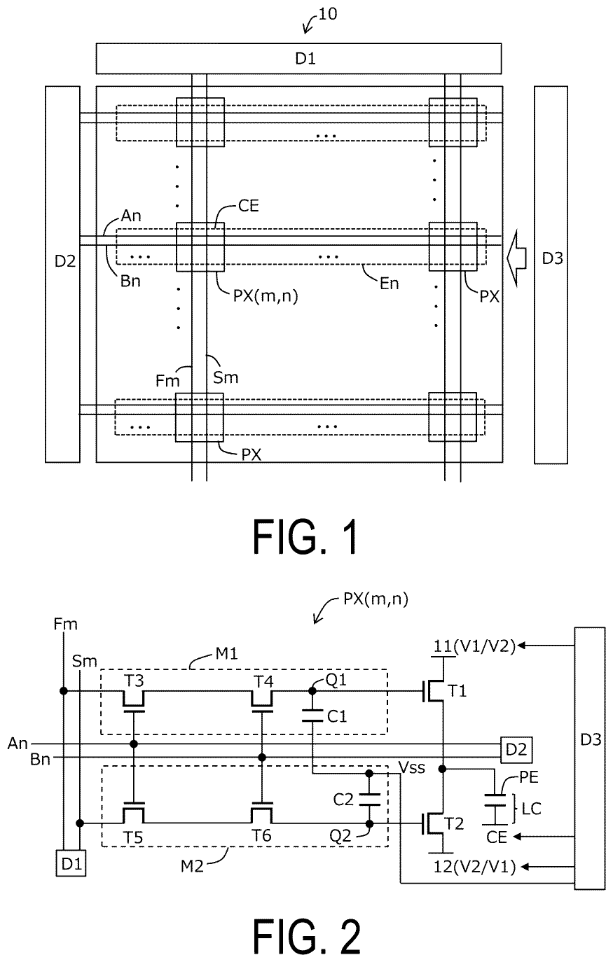

FIG. 1 is a block diagram illustrating a configuration of portions of a liquid crystal display device according to the embodiment. FIG. 2 is a circuit diagram illustrating a pixel configuration example of a liquid crystal display device. As illustrated in FIGS. 1 and 2, the liquid crystal display device 10 includes pixels PX each including a pixel electrode PE, a first power source line 11, and a second power source line 12, the pixel PX includes a first memory circuit M1 and a second memory circuit M2, a first transistor T1 connected to the first memory circuit M1, and a second transistor T2 connected to the second memory circuit M2, and the pixel electrode PE is connected to the first power source line 11 via the first transistor T1 and is connected to the second power source line 12 via the second transistor T2. A pixel PX(m,n) in FIGS. 1 and 2 is one (a pixel in an m-th column and an n-th row) of a pixel group arranged in, for example, a matrix shape.

According to the liquid crystal display device 10, by controlling the first transistor T1 with the voltage held by the first memory circuit M1 and controlling the second transistor T2 with a voltage (memory voltage) held by the second memory circuit M2, the display voltage can be written to the pixel electrode PE from the first power source line 11 or the second power source line 12. As a result, a refresh frequency can be reduced (a refresh interval can be increased) while maintaining the quality (for example, low flicker) of memory display. The pixel PX may include the pixel electrode PE, a counter electrode CE, and a liquid crystal capacitance LC including a liquid crystal layer. The counter electrode CE may be a common electrode shared by a plurality of pixels.

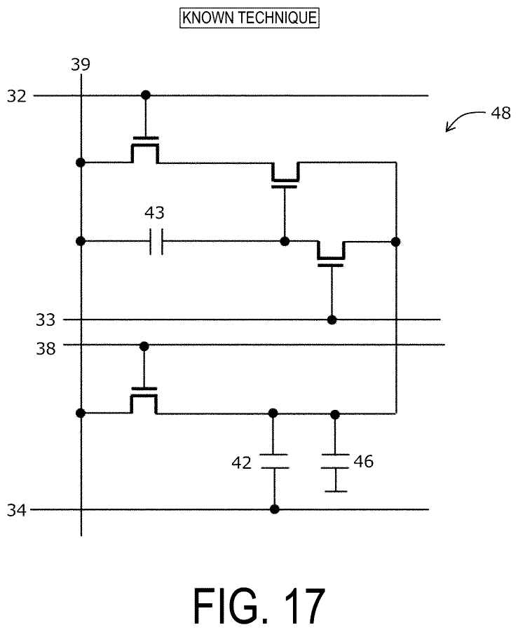

In the known art disclosed in JP 2012-93436 A (FIG. 17) (memory type liquid crystal pixel 48 connected to a refresh line 32, a data line 39, a gate line 38, a sampling line 33 and a CS line 34 and including a sampling capacitance 43, a storage capacitance 42 and a liquid crystal capacitance 46), since the storage capacitance 42 and the liquid crystal capacitance 46 are connected in parallel and a voltage of the storage capacitance 42 and a voltage of the liquid crystal capacitance 46 are held in the same configuration, a luminance change is large at the time of refresh and a flicker is easily visually recognized.

On the other hand, in the liquid crystal display device 10, the memory voltages (for example, binary values) of the first and second memory circuits M1 and M2 and a voltage of the liquid crystal capacitance LC are held in separate configurations, and thus a luminance change is small at the time of refresh, and a flicker is hardly visually recognized.

Note that the memory potential gradually attenuates, and thus a control circuit can be also provided outside (outside the pixel) in which the control circuit reads the memory voltages from the first and second memory circuits T1 and T2 at intervals that do not cause loss of information and writes the read memory voltages back to the first and second memory circuits T1 and T2.

During a display period, one of the first and second transistors T1 and T2 turns on and the other turns off, and thus the first potential V1 or the second potential V2 lower than the first potential V1 may be supplied to the pixel electrode PE.

The pixel PX may perform binary display of black gray scale and white gray scale. The display of the black gray scale means black display in the pixel PX. The display of the white gray scale may mean primary color display (for example, display of any one of red, green, and blue) in the pixel PX or white display in the pixel PX. When the primary color display is performed in the pixel PX, color display of eight colors is possible.

The liquid crystal display device 10 may include a first data line Fm and a second data line Sm, and a first control line An and a second control line Bn. The first memory circuit M1 may include a first capacitance C1, a third transistor T3, and a fourth transistor T4, and the second memory circuit M2 may include a second capacitance C2, a fifth transistor T5, and a sixth transistor T6. Gate terminals of the third and fifth transistors T3 and T5 may be connected to the first control line An, and gate terminals of the fourth and sixth transistors T4 and T6 may be connected to the second control line Bn.

The first data line Fm may be connected to a gate terminal of the first transistor T1 via the third and fourth transistors T3 and T4. The second data line Sm may be connected to a gate terminal of the second transistor T2 via the fifth and sixth transistors T5 and T6. The gate terminal of the first transistor T1 may be connected to the first capacitance C1, and the gate terminal of the second transistor T2 may be connected to the second capacitance C2.

In the liquid crystal display device 10, by setting the first and second control lines An and Bn to an active potential to turn on the third to sixth transistors T3 to T6 during the writing period, one of a positive logic voltage (for example, VH) and a negative logic voltage (for example, VL) may be written from the first data line Fm to the first capacitance C1, and the other of the positive logic voltage (for example, VH) and the negative logic voltage (for example, VL) may be written from the second data line Sm to the second capacitance C2. The writing period means a period of refreshing (without changing the frame data) or a period of rewriting (with changing the frame data) a potential of an output Q1 of the first memory circuit M1 and a potential of an output Q2 of the second memory circuit M2.

When the pixel PX is a normally black type, the white gray scale display may be performed during a period in which the pixel electrode PE is at the first potential V1 and the counter electrode CE is at the second potential V2 and a period in which the pixel electrode PE is at the second potential V2 and the counter electrode CE is at the first potential V1, and the black gray scale display may be performed during a period in which the pixel electrode PE is at the first potential V1 and the counter electrode CE is at the first potential V1 and a period in which the pixel electrode PE is at the second potential V2 and the counter electrode CE is at the second potential V2.

When the pixel PX is a normally white type, the white gray scale display may be performed during the period in which the pixel electrode PE is at the first potential V1 and the counter electrode CE is at the first potential V1 and the period in which the pixel electrode PE is at the second potential V2 and the counter electrode CE is at the second potential V2, and the black gray scale display may be performed during the period in which the pixel electrode PE is at the first potential V1 and the counter electrode CE is at the second potential V2 and the period in which the pixel electrode PE is at the second potential V2 and the counter electrode CE is at the first potential V1.

The first and second transistors T1 and T2 may have the same type channel, and the positive logic potential may be stored in the first memory circuit M1 and the negative logic potential may be stored in the second memory circuit M2, so that the first transistor T1 may turn on and the second transistor T2 may turn off, and the negative logic potential may be stored in the first memory circuit M1 and the positive logic potential may be stored in the second memory circuit M2, so that the first transistor T1 may turn off and the second transistor T2 may turn on.

When the first and second transistors T1 and T2 have N-type channels, the positive logic potential may be VH (memory potential on a high potential side) and the negative logic potential may be VL (memory potential on a low potential side), and when the first and second transistors T1 and T2 have P-type channels, the positive logic potential may be VL (memory potential on the low potential side) and the negative logic potential may be VH (memory potential on the high potential side).

In the pixel PX, the first and second transistors T1 and T2 may alternately turn on during the display period of the white gray scale. In this way, a characteristic change (shift in I-V characteristics) that may occur when a transistor turns on for a long period of time can be avoided for the first and second transistors T1 and T2. In accordance with the first and second transistors T1 and T2 being alternately turned on, the potentials (power source potentials) of the first and second power source lines 11 and 12 may be exchanged to each other, or the potential of the counter electrode CE may be exchanged.

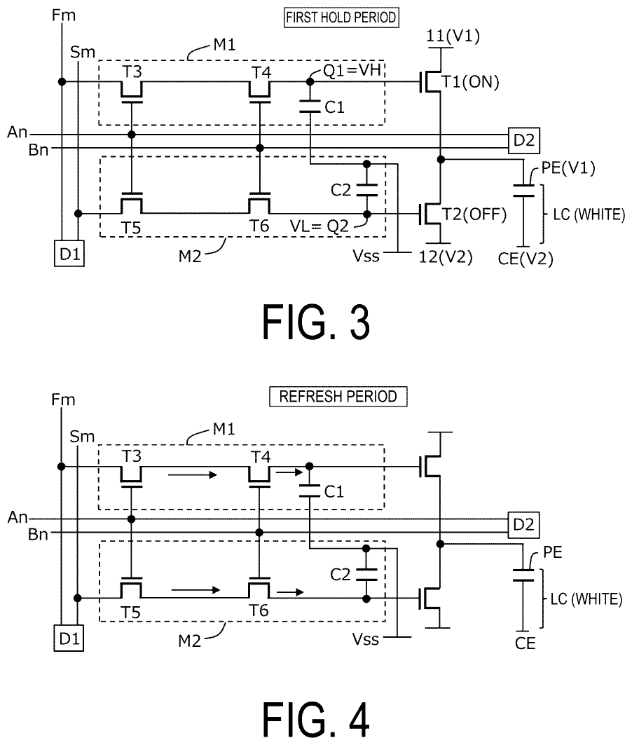

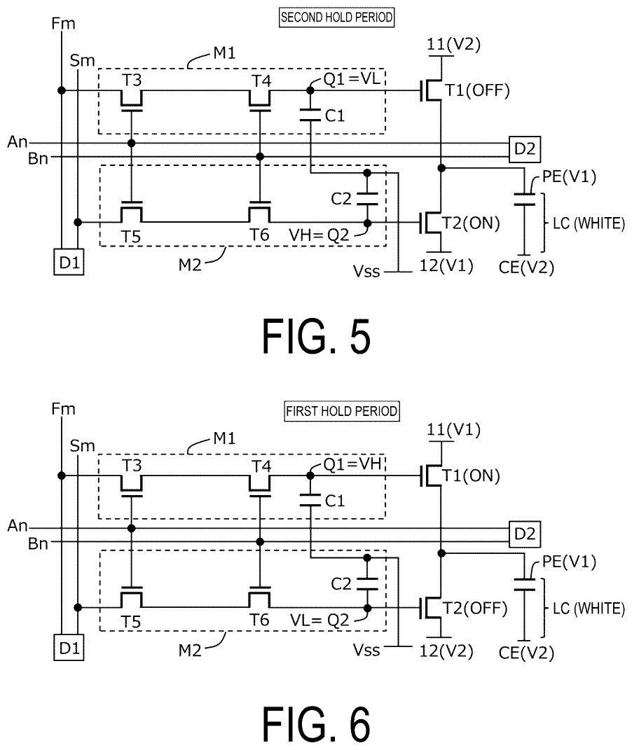

FIGS. 3 to 5 are schematic views each illustrating an operation example of a liquid crystal display device according to the embodiment. As illustrated in FIGS. 3 to 5, the display period of the white gray scale in the normally black type may include a first hold period in which the first transistor T1 turns on (T2 turns off) and the first potential V1 is supplied from the first power source line 11 to the pixel electrode PE and the second potential V2 is supplied to the counter electrode CE, and a second hold period in which the second transistor T2 turns on (T1 turns off) and the first potential V1 is supplied from the second power source line 12 to the pixel electrode PE and the second potential V2 is supplied to the counter electrode CE, and the refresh period may be provided between the first hold period and the second hold period.

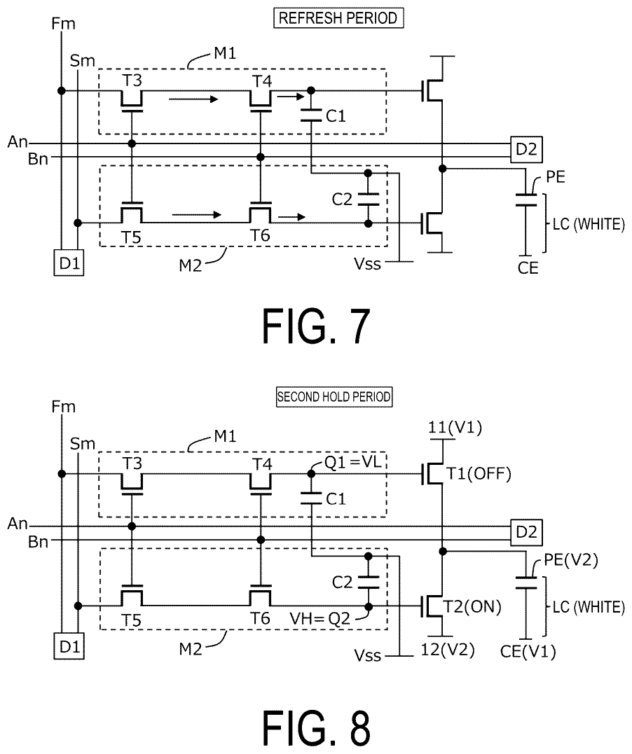

FIGS. 6 to 8 are schematic views each illustrating an operation example of a liquid crystal display device according to the embodiment. As illustrated in FIGS. 6 to 8, the display period of the white gray scale in the normally black type may include a first hold period in which the first transistor T1 turns on (T2 turns off) and the first potential V1 is supplied from the first power source line 11 to the pixel electrode PE and the second potential V2 is supplied to the counter electrode CE, and a second hold period in which the second transistor T2 turns on (T1 turns off) and the second potential V2 is supplied from the second power source line 12 to the pixel electrode PE and the first potential V1 is supplied to the counter electrode CE, and the refresh period may be provided between the first hold period and the second hold period.

In the pixel PX, the first and second transistors may alternately turn on during the display period of the black gray scale. In this way, the characteristic change (shift in I-V characteristics) that may occur when a transistor turns on or off for a long period of time can be avoided for the first and second transistors T1 and T2. In accordance with the first and second transistors T1 and T2 being alternately turned on, the potentials (power source potentials) of the first and second power source lines 11 and 12 may be exchanged to each other, or the potential of the counter electrode CE may be exchanged.

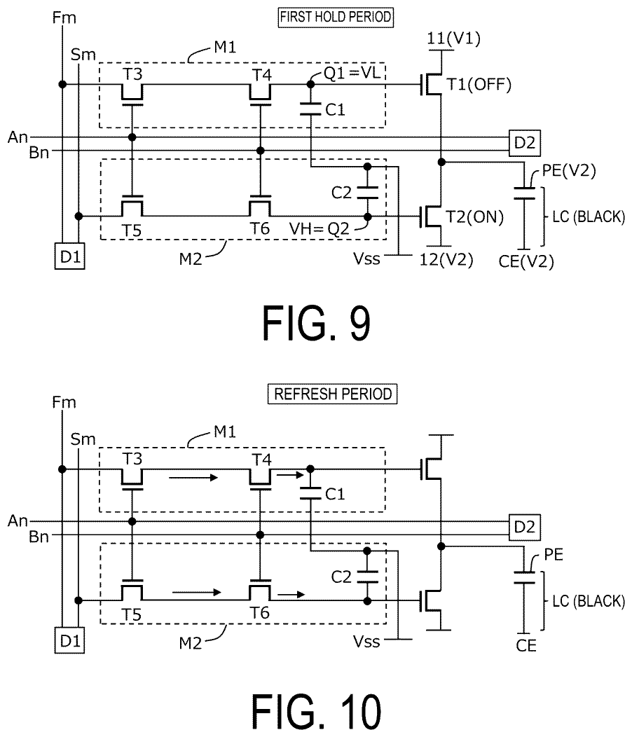

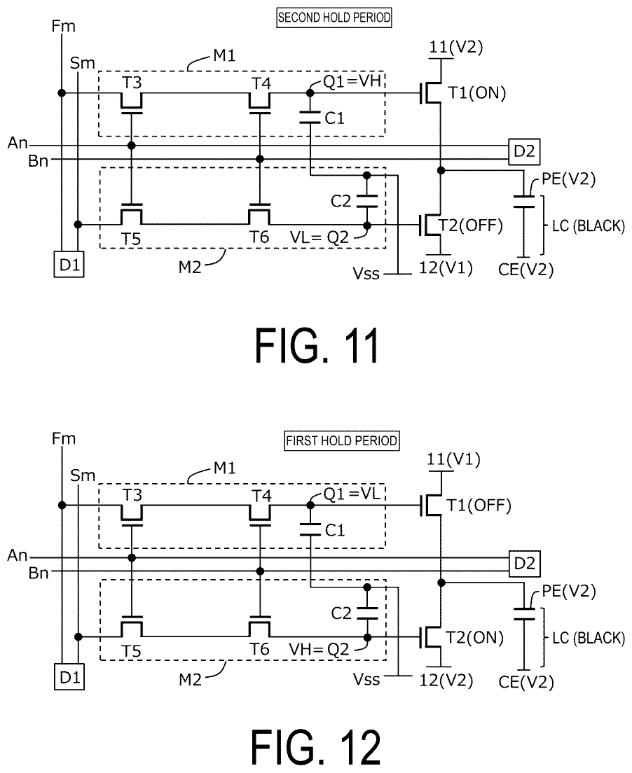

FIGS. 9 to 11 are schematic views each illustrating an operation example of a liquid crystal display device according to the embodiment. As illustrated in FIGS. 9 to 11, the display period of the black gray scale in the normally black type may include a first hold period in which the second transistor T2 turns on (T1 turns off) and the second potential V2 is supplied from the second power source line 12 to the pixel electrode PE and the second potential V2 is supplied to the counter electrode CE, and a second hold period in which the first transistor T1 turns on (T2 turns off) and the second potential V2 is supplied from the first power source line 11 to the pixel electrode PE and the second potential V2 is supplied to the counter electrode CE, and the refresh period may be provided between the first hold period and the second hold period.

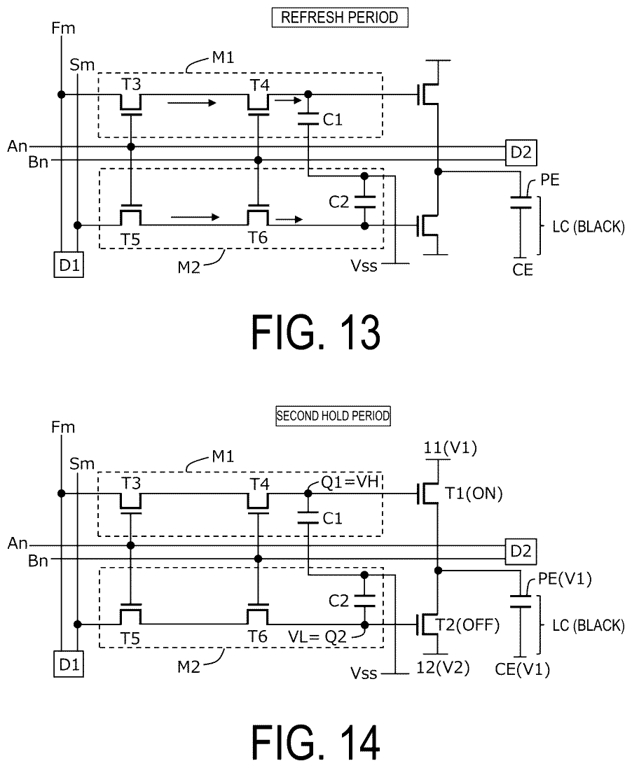

FIGS. 12 to 14 are schematic views each illustrating an operation example of a liquid crystal display device according to the embodiment. As illustrated in FIGS. 12 to 14, the display period of the black gray scale in the normally black type may include a first hold period in which the second transistor T2 turns on (T1 turns off) and the second potential V2 is supplied from the second power source line 12 to the pixel electrode PE and the second potential V2 is supplied to the counter electrode CE, and a second hold period in which the first transistor T1 turns on (T2 turns off) and the first potential V1 is supplied from the first power source line 11 to the pixel electrode PE and the first potential V1 is supplied to the counter electrode CE, and the refresh period may be provided between the first hold period and the second hold period.

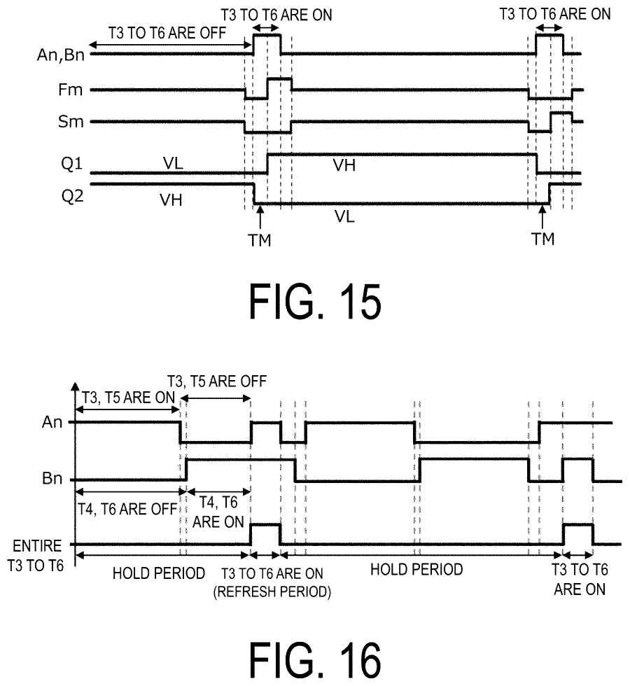

FIG. 15 is a timing chart showing an example of signal waveforms of a first and a second data lines and a first and a second control lines. As illustrated in FIG. 15, a period may be included in which transition is performed from a state in which the first transistor T1 is on (Q1 is VH) and the second transistor T2 is off (Q2 is VL) to a state in which the first and second transistors T1 and T2 are both off (Q1 and Q2 are VL) and then to a state in which the first transistor T1 is off (Q1 is VL) and the second transistor T2 is on (Q2 is VH). As described above, by providing a period TM in which the first and second transistors T1 and T2 both turn off (Q1 and Q2 are VL) before the transition of the state of each of the first and second transistors T1 and T2, the short circuit of the first and second power source lines 11 and 12 due to the first and second transistors T1 and T2 simultaneous turning on can be avoided.

FIG. 16 is a timing chart showing an example of signal waveforms of the first and the second control lines. In the liquid crystal display device 10, one of the first and second control lines An and Bn may be at an active potential and the other may be at a non-active potential during the hold period (a period during which the outputs Q1 and Q2 of the first and second memory circuits M1 and M2 are maintained). In this way, the third and fifth transistors T3 and T5 can be turned on (T4 and T6 are turned off) and the fourth and sixth transistors T4 and T6 can be turned on (T3 and T5 are turned off) while maintaining the potential (memory potential) of the output node Q1 of the first memory circuit M1 and the potential (memory potential) of the output node Q2 of the second memory circuit M2. As a result, the characteristic change (shift in I-V characteristics) that may occur when each of the third to sixth transistors T3 to T6 is turned on or off for a long period of time can be reduced.

In the hold period, the first and second control lines An and Bn may be alternately at the active potential. In this way, each of the third to sixth transistors T3 to T6 can be periodically turned on and off, and the characteristic change of each transistor can be more effectively reduced.

As illustrated in FIG. 16, in the hold period, in order to prevent the third to sixth transistors from both turning on, it is desirable that a potential shift timing (for example, fall) of a pulse of the first control line An and a potential shift timing (for example, rise) of a pulse of the second control line Bn are shifted from each other.

In the liquid crystal display device 10, the first to sixth transistors T1 to T6 may have the same type channel, and the first to sixth transistors T1 to T6 may have channels containing oxide semiconductors. At least one of the first to sixth transistors T1 to T6 may have an N-type channel containing an oxide semiconductor. The oxide semiconductor may be indium gallium zinc oxide.

In the liquid crystal display device 10, a pixel row PL including a plurality of the pixels PX arranged in the row direction may share the first and second power source lines 11 and 12, and the pixel row PL may share the counter electrode CE. The pixel row PL may share the first and second power source lines 11 and 12 and the counter electrode CE.

The liquid crystal display device 10 may include a first driver circuit D1 for driving the first and second data lines Fm and Sm, a second driver circuit D2 for driving the first and second control lines An and Bn, and a third driver circuit D3 for driving the first and second power source lines 11 and 12 and the counter electrode CE.

The liquid crystal display device 10 is suitable for so-called digital signage. In a display for signage, a transistor for sampling and holding turns off for a long period of time, and transistor characteristics may change; however, in the liquid crystal display device 10, the states of not only the first and second transistors T1 and T2 but also the third to sixth transistors T3 to T6 can be periodically transitioned (from on to off, from off to on) while maintaining the display state (memory display). Thus, the possibility that the transistor characteristics change is reduced.

For example, in the case of a transistor having an N-type channel, when an off period (gate voltage=off voltage) continues for a long period of time, V-I characteristics shift to a low voltage side, and then a current flows even when the gate voltage is the off voltage, and the transistor does not function as a current control element. On the other hand, when an on period (gate voltage=on voltage) continues for a long period of time, the V-I characteristics shift to a high voltage side, and then a current decreases even when the gate voltage is the on voltage, and the transistor does not function as the current control element. A tendency of such a characteristic change is observed also in a transistor whose channel is the oxide semiconductor. Thus, as in the liquid crystal display device 10, the gate potentials of not only the first and second transistors T1 and T2 but also the third to sixth transistors T3 to T6 are periodically exchanged to the off voltage or the on voltage, so that the V-I characteristics can be fixed and the transistors can appropriately function as the current control elements. As a result, power consumption can be reduced while maintaining the quality of the memory display such as low flicker.

As described above, in the liquid crystal display device 10, a still image can be displayed (memory display) with low power consumption and high quality over a long period of time, but moving picture display can also be displayed by increasing a write frequency.

The embodiments described above are for the purpose of illustration and description and are not intended to be limiting. It will be apparent to those skilled in the art that many variations will be possible in accordance with these examples and descriptions. The gist of this embodiment will be described below.

A liquid crystal display device including
a pixel including a liquid crystal capacitance, a first power source line, and a second power source line, wherein the pixel includes a first memory circuit, a second memory circuit, a first transistor connected to the first memory circuit, and a second transistor connected to the second memory circuit, and
the liquid crystal capacitance is connected to the first power source line via the first transistor and is connected to the second power source line via the second transistor.

The liquid crystal display device described above, wherein the liquid crystal capacitance includes a pixel electrode, a counter electrode, and
a liquid crystal layer, and during a display period, one of the first and second transistors turns on and the other turns off, and thus a first potential or a second potential lower than the first potential is supplied to the pixel electrode.

The liquid crystal display device described above, wherein the pixel performs binary display of black gray scale and white gray scale.

The liquid crystal display device described above,
wherein the first and second transistors each include the same type channel,
a positive logic potential is stored in the first memory circuit and a negative logic potential is stored in the second memory circuit, so that the first transistor turns on and the second transistor turns off, and
   the negative logic potential is stored in the first memory circuit and the positive logic potential is stored in the second memory circuit, so that the first transistor turns off and the second transistor turns on.

The liquid crystal display device described above, wherein the first and second transistors are alternately turned on during a display period of the white gray scale.

The liquid crystal display device described above, wherein the display period of the white gray scale includes a period in which the first transistor turns on and the first potential is supplied from the first power source line to the pixel electrode and the second potential is supplied to the counter electrode, and a period in which the second transistor turns on and the first potential is supplied from the second power source line to the pixel electrode and the second potential is supplied to the counter electrode.

The liquid crystal display device described above, wherein the display period of the white gray scale includes a period in which the first transistor turns on and the first potential is supplied from the first power source line to the pixel electrode and the second potential is supplied to the counter electrode, and a period in which the second transistor turns on and the second potential is supplied from the second power source line to the pixel electrode and the first potential is supplied to the counter electrode.

The liquid crystal display device described above, wherein the first and second transistors are alternately turned on during a display period of the black gray scale.

The liquid crystal display device described above, wherein the display period of the black gray scale includes a period in which the second transistor turns on and the second potential is supplied from the second power source line to the pixel electrode and the second potential is supplied to the counter electrode, and a period in which the first transistor turns on and the second potential is supplied from the first power source line to the pixel electrode and the second potential is supplied to the counter electrode.

The liquid crystal display device described above, wherein the display period of the black gray scale includes a period in which the second transistor turns on and the second potential is supplied from the second power source line to the pixel electrode and the second potential is supplied to the counter electrode, and a period in which the first transistor turns on and the first potential is supplied from the first power source line to the pixel electrode and the first potential is supplied to the counter electrode.

The liquid crystal display device described above, wherein a period is included in which transition is performed from a state in which the first transistor is on and the second transistor is off to a state in which the first and second transistors are both off and then to a state in which the first transistor is off and the second transistor is on.

The liquid crystal display device described above, further including
a first data line, a second data line, a first control line, and a second control line,
wherein the first memory circuit includes a first capacitance, a third transistor, and a fourth transistor,
the second memory circuit includes a second capacitance, a fifth transistor, and a sixth transistor,
gate terminals of the third and fifth transistors are connected to the first control line,
gate terminals of the fourth and sixth transistors are connected to the second control line,
the first data line is connected to a gate terminal of the first transistor via the third and fourth transistors,
the second data line is connected to a gate terminal of the second transistor via the fifth and sixth transistors,
the gate terminal of the first transistor is connected to the first capacitance, and
the gate terminal of the second transistor is connected to the second capacitance.

The liquid crystal display device described above, wherein by setting the first and second control lines to an active potential to turn on the third to sixth transistors during a writing period, one of a positive logic voltage and a negative logic voltage is written from the first data line to the first capacitance and the other of the positive logic voltage and the negative logic voltage is written from the second data line to the second capacitance.

The liquid crystal display device described above, wherein one of the first and second control lines is at the active potential and the other is at a non-active potential during a period in which outputs of the first and second memory circuits are held.

The liquid crystal display device described above, wherein the first and second control lines are alternately at the active potential during the period in which the outputs of the first and second memory circuits are held.

The liquid crystal display device described above, wherein the first to sixth transistors each include the same type channel.

The liquid crystal display device described above, wherein the first to sixth transistors each include a channel including an oxide semiconductor.

The liquid crystal display device described above, wherein a pixel row including the pixel shares the first power source line, the second power source line, and the counter electrode.

The liquid crystal display device described above further including a first driver circuit configured to drive the first data line and the second data line, and a second driver circuit configured to drive the first control line and the second control line.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
a pixel including a pixel electrode;
a first power source line; and
a second power source line,
wherein the pixel includes a first memory circuit, a second memory circuit, a first transistor connected to the first memory circuit, and a second transistor connected to the second memory circuit, and
the pixel electrode is connected to the first power source line via the first transistor and is connected to the second power source line via the second transistor.

2. The liquid crystal display device according to claim 1,
wherein the pixel includes a liquid crystal capacitance including the pixel electrode, a counter electrode, and a liquid crystal layer, and
during a display period, one of the first and second transistors turns on and the other turns off, and thus a first potential or a second potential lower than the first potential is supplied to the pixel electrode.

3. The liquid crystal display device according to claim 2,
wherein the pixel performs binary display of black gray scale and white gray scale.

4. The liquid crystal display device according to claim 2,
wherein the first and second transistors each include the same type channel,
a positive logic potential is stored in the first memory circuit and a negative logic potential is stored in the second memory circuit, and thus the first transistor turns on and the second transistor turns off, and
the negative logic potential is stored in the first memory circuit and the positive logic potential is stored in the second memory circuit, and thus the first transistor turns off and the second transistor turns on.

5. The liquid crystal display device according to claim 3,
wherein the first and second transistors are alternately turned on during a display period of the white gray scale.

6. The liquid crystal display device according to claim 5,
wherein the display period of the white gray scale includes a period in which the first transistor turns on and the first potential is supplied from the first power source line to the pixel electrode and the second potential is supplied to the counter electrode, and a period in which the second transistor turns on and the first potential is supplied from the second power source line to the pixel electrode and the second potential is supplied to the counter electrode.

7. The liquid crystal display device according to claim 5,
wherein the display period of the white gray scale includes a period in which the first transistor turns on and the first potential is supplied from the first power source line to the pixel electrode and the second potential is supplied to the counter electrode, and a period in which the second transistor turns on and the second potential is supplied from the second power source line to the pixel electrode and the first potential is supplied to the counter electrode.

8. The liquid crystal display device according to claim 3,
wherein the first and second transistors are alternately turned on during a display period of the black gray scale.

9. The liquid crystal display device according to claim 8,
wherein the display period of the black gray scale includes a period in which the second transistor turns on and the second potential is supplied from the second power source line to the pixel electrode and the second potential is supplied to the counter electrode, and a period in which the first transistor turns on and the second potential is supplied from the first power source line to the pixel electrode and the second potential is supplied to the counter electrode.

10. The liquid crystal display device according to claim 8,
wherein the display period of the black gray scale includes a period in which the second transistor turns on and the second potential is supplied from the second power source line to the pixel electrode and the second potential is supplied to the counter electrode, and a period in which the first transistor turns on and the first potential is supplied from the first power source line to the pixel electrode and the first potential is supplied to the counter electrode.

11. The liquid crystal display device according to claim 5,
wherein a period is included in which transition is performed from a state in which the first transistor is on and the second transistor is off to a state in which the first and second transistors are both off and then to a state in which the first transistor is off and the second transistor is on.

12. The liquid crystal display device according to claim 1, further comprising:
a first data line;
a second data line;
a first control line; and
a second control line,
wherein the first memory circuit includes a first capacitance, a third transistor, and a fourth transistor,
the second memory circuit includes a second capacitance, a fifth transistor, and a sixth transistor,
gate terminals of the third and fifth transistors are connected to the first control line,
gate terminals of the fourth and sixth transistors are connected to the second control line,
the first data line is connected to a gate terminal of the first transistor via the third and fourth transistors,
the second data line is connected to a gate terminal of the second transistor via the fifth and sixth transistors,
the gate terminal of the first transistor is connected to the first capacitance, and
the gate terminal of the second transistor is connected to the second capacitance.

13. The liquid crystal display device according to claim 12,
wherein by setting the first and second control lines to an active potential to turn on the third to sixth transistors during a writing period, one of a positive logic voltage and a negative logic voltage is written from the first data line to the first capacitance and the other of the positive logic voltage and the negative logic voltage is written from the second data line to the second capacitance.

14. The liquid crystal display device according to claim 13,
wherein one of the first and second control lines is at the active potential and the other is at a non-active potential during a period in which outputs of the first and second memory circuits are held.

15. The liquid crystal display device according to claim 14,
wherein the first and second control lines are alternately at the active potential during the period in which the outputs of the first and second memory circuits are held.

16. The liquid crystal display device according to claim 12,
wherein the first to sixth transistors each include the same type channel.

17. The liquid crystal display device according to claim 12,
wherein the first to sixth transistors each include a channel including an oxide semiconductor.

18. The liquid crystal display device according to claim 2,
wherein a pixel row including the pixel shares the first power source line, the second power source line, and the counter electrode.

19. The liquid crystal display device according to claim 12, further comprising:
a first driver circuit configured to drive the first data line and the second data line; and
a second driver circuit configured to drive the first control line and the second control line.
